(19) United States
(12) Patent Application Publication
(10) Pub. No.: US 2006/0055180 A1
(43) Pub. Date: Mar. 16, 2006

(54) Motor vehicle lock

(75) Inventors: Checrallah Kachouh, Dortmund (DE); Markus Kothe, Velbert (DE)

Correspondence Address: NIXON PEABODY, LLP, 401 9TH STREET, NW, SUITE 900, WASHINGTON, DC, 20004-2128, US

(73) Assignee: Brose Schliesssysteme GmbH & Co. KG, Wuppertal (DE)

(21) Appl. No.: 11/201,312

(22) Filed: Aug. 11, 2005

(30) Foreign Application Priority Data
Sep. 16, 2004 (DE) 10 2004 045 283.0

(51) Int. Cl. E05C 3/06; E05C 3/16

(52) U.S. Cl. 292/216

(57) ABSTRACT

A motor vehicle lock with a latch and a ratchet, the latch being pivotable around a pivot axis, and being movable into an open position and into at least a fully latched position and the ratchet being movable into at least one holding position and into a release position, the ratchet holding the latch in the fully latched position in the holding position. Additional kinematics are coupled in a pivoting and undetachable manner to the latch so that the resetting motion of the latch out of the fully latched position in the direction of the open position causes movement of the additional kinematics and the additional kinematics are coupled to an elastic resistance element at least when the latch is in the fully latched position so that the action of the force of the resistance element on the additional kinematics causes inhibition of the first segment of the resetting motion.

### BACKGROUND OF THE INVENTION

1. Field of Invention

This invention relates to a motor vehicle lock with a latch and a ratchet, the latch being able to pivot around a pivot axis, the latch being movable into an open position, into a fully latched position and possibly into a half-latched position, the ratchet being movable into at least one holding position and into a release position, the ratchet which is in the holding position, in any case, holding the latch in the fully latched position. Here, a “motor vehicle lock” encompasses all types of side, hood and hatch locks.

2. Description of Related Art

The motor vehicle lock under consideration which underlies the invention (European Patent Application EP 589 158 A1) is equipped with the conventional lock elements, latch and ratchet. The latch can be pivoted around a pivot axis and can be moved into the open position and into the fully latched position. The ratchet can be moved into a holding position in which it keeps the latch in the fully latched position, and into a release position. The ratchet which is in the holding position directly engages the latch.

When the latch is in the fully latched position, it is provided that the latch is nonpositively engaged to the striker which is located on an assigned motor vehicle door, by which the vehicle door is held in the closed position. In particular, due to the counterpressure of the seal which is caused by the door seal, high holding forces in this state act from the latch on the striker, and accordingly, from the ratchet on the latch. In the opening process, which is initiated by moving the ratchet from the holding position into the release position, these high forces lead to sudden resetting of the latch, and accordingly, to a sudden opening motion of the motor vehicle door. Such a sudden opening process is fundamentally associated with high, undesirable opening noise which is also perceived as “opening bang.”

The loud opening noise is caused, among others, by the ratchet disengaging from the latch which is under a high level of pretensioning which is caused essentially by the described seal counterpressure. The impulsive motion of the motor vehicle door leads to further noise development.

Furthermore, due to the high pretensioning of the latch the force, which is necessary for moving the ratchet from the holding position into the release position, and is also comparatively high since the friction between the ratchet, on the one hand, and the latch, on the other, is correspondingly high. The high lifting force, depending on the structural configuration, leads, first of all, to elastic deformation of the components which are involved when the ratchet is lifted. They are, for example, levers, connecting elements or the like. After completed lifting of the ratchet, these components are suddenly transferred into their original state; this causes further opening noise or even an opening bang.

### SUMMARY OF THE INVENTION

A primary object of this invention is to configure and develop the known motor vehicle lock such that a reduction of opening noise is ensured with minimum construction effort.

This object is achieved in a motor vehicle lock by the provision of additional kinematics which are coupled in a pivoting and undetachable manner to the latch, the resetting motion of the latch out of the fully latched position in the direction of the open position causing movement of the additional kinematics. The additional kinematics are or can be nonpositively coupled to an elastic resistance element and the action of the force of the resistance element on the additional kinematics causes inhibition of the first segment of the resetting motion.

First of all, the pivoting and undetachable coupling of additional kinematics to the latch is important. This results in that the resetting motion of the latch out of the fully latched position in the direction of the open position, at the same time, causes movement of the additional kinematics. Therefore, to a certain extent forced coupling between the additional kinematics and the latch is accomplished.

Furthermore, it is important that the additional kinematics are or can be coupled nonpositively to an elastic resistance element. The concept of “elastic” should be broadly construed here and means simply that there is no blocking of the additional kinematics, and thus, of the latch by the resistance element. “Can be coupled” means that the action of the force from the resistance element starts if necessary only after the beginning of the resetting motion. Provided that there is action of the force from the resistance element on the latch when the latch is in the fully latched position, in this way, the friction which opposes the lifting of the ratchet is reduced accordingly, because the action of the force of the resistance element is directed in the closing direction.

At this point, the arrangement is such that the action of the force of the resistance element on the additional kinematics causes inhibition of the first segment of the resetting motion of the latch out of the fully latched position in the direction of the open position. Therefore, after the movement of the ratchet from the holding position into the release position, the resetting motion of the latch is inhibited, but not blocked by the action of the force of the resistance element on the additional kinematics. Accordingly, the resetting motion takes place in a first segment of motion with a comparatively slow speed. The sudden resetting motion of the latch with the associated opening noise can thus be reliably precluded.

By the ratchet being coupled to the additional kinematics such that the ratchet, in the holding position, is in blocking engagement with the additional kinematics, and thus, keeps the latch in the fully latched position, and in the half-latched position which may be present, additionally enables a reduction of the force which is required for moving the ratchet from the holding position into the release position; this in turn leads to a reduction of the opening noise. In any case, depending on the structural edge movements it can also be advantageous for the ratchet to be movable into direct engagement with the latch.

The structural configuration of the additional kinematics by which the additional kinematics together with the latch form a four-bar mechanism in which the additional kinematics has a locking lever which can be pivoted around a pivot axis, and an intermediate lever which is coupled with a pivoting capacity to the latch, on the one hand, and to the locking lever, on the other, leads to especially simple and effective approaches.

The invention is explained in detail below with reference to the accompanying the drawings. In the course of these explanations, other embodiments and developments as well as other features, properties, aspects and advantages of the invention are also explained.

### BRIEF DESCRIPTION OF THE DRAWINGS

FIG. 1 shows a motor vehicle lock with a latch, ratchet and additional kinematics in the fully latched position,

FIG. 2 shows another motor vehicle lock with a latch, ratchet and additional kinematics in the fully latched position, and

FIG. 3 shows an alternative embodiment with a damping type resistance element.

### DETAILED DESCRIPTION OF THE INVENTION

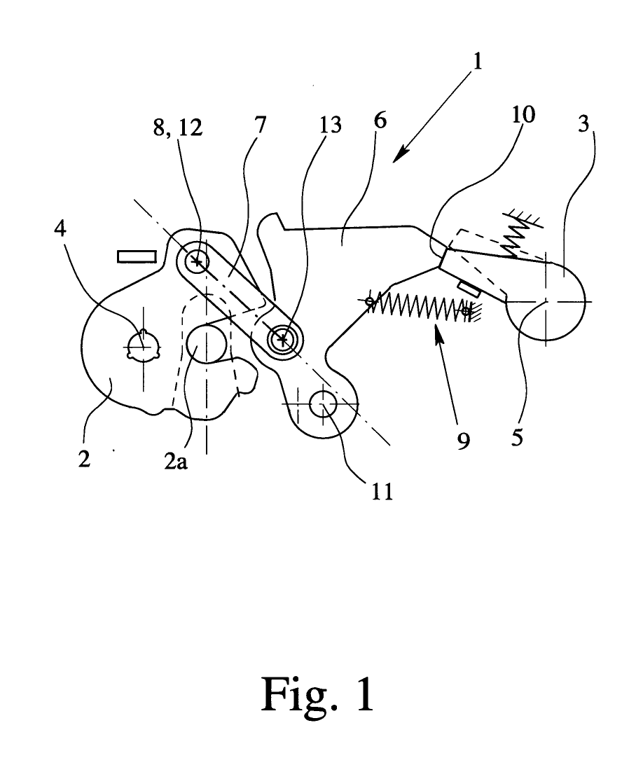

In the drawings FIG. 1 shows a motor vehicle lock 1 with a latch 2 which can be moved into nonpositive (i.e., unsecured) engagement with a striker 2a which is located on the assigned vehicle door, and a ratchet 3. The latch 2 can be pivoted around a pivot axis 4 and can be moved into an open position, a fully latched position and a half-latched position. Depending on the application, it can also be advantageous to eliminate the half-latched position. The ratchet 3 can be moved into the holding position which is shown in FIG. 1 and into a release position. The ratchet 3, when it is in the holding position, holds the latch 2 in the fully latched position and in the half-latched position. The movement of the ratchet 3 into the release position, in the embodiment which is shown in FIG. 1, is associated with pivoting of the ratchet 3 around a pivot axis 5 to the right. The ratchet 3 which is in the release position is shown by the broken line in FIG. 1.

The latch 2 is assigned additional kinematics 6, 7 which are made here as lever kinematics and are explained in detail below.

It is important that the additional kinematics 6, 7 be pivotably coupled in an undetachable manner to the latch 2 via the pivot axis 8. It has already been pointed out that, in this way, the additional kinematics 6, 7 are forcibly coupled to the latch 2 so that the resetting motion of the latch 2 out of the fully latched position in the direction of the open position, in FIG. 1 around to the right, causes a corresponding movement of the additional kinematics 6, 7.

Furthermore, it is important that the additional kinematics 6, 7 be coupled to an elastic resistance element 9, and that the action of the force of the resistance element 9 on the additional kinematics 6, 7 cause inhibition of the first segment of the resetting motion of the latch 2. Here, this coupling, in any case, is ensured in the first segment of the resetting motion so that a sudden opening process as described above is prevented. The first segment of the resetting motion is, for example, the first 25% of the resetting motion.

The resistance element 9 can be configured and arranged such that, when the latch 2 is in the fully latched position, the resistance element applies a force to the additional kinematics 6, 7 in the sense of pretensioning of the additional kinematics 6, 7. However, it can also be advantageous for the resistance element 9 to apply a corresponding force to the additional kinematics 6, 7 only after the start of the resetting motion.

In the embodiment shown in FIG. 1, the ratchet 3 is coupled to the additional kinematics 6, 7 such that the ratchet 3 which is in the holding position is in blocking engagement with the additional kinematics 6, 7, and thus, keeps the latch 2 in the fully latched position and in the half-latched position.

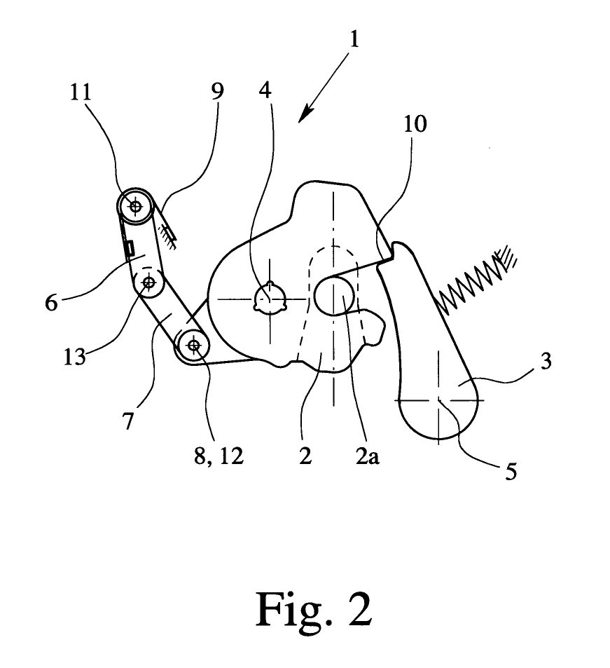

The likewise preferred embodiment which is shown in FIG. 2 shows a separate arrangement of the additional kinematics 6, 7, on the one hand, and the ratchet 3, on the other hand. FIG. 2 shows the ratchet 3 which is in the holding position and which is in directly blocking engagement with the main catch 10 of the latch 2. It is pointed out that, depending on the application, there can be a corresponding preliminary catch, as such is known in the art.

With respect to the inhibition of the resetting motion of the latch 2 in accordance with the invention, the two embodiments shown in FIGS. 1 & 2, follow the same basic principle. All the statements made in this respect can therefore be applied without limitation to the two embodiments.

Numerous possibilities are known from the prior art for the configuration of the resistance element 9. One simple and economical version for the resistance element 9 to be formed as a spring element. The spring element can be, for example, a metal or rubber spring or a pneumatically acting spring.

Basically, in the design of the resistance element 9, it must be taken into account that the resistance element 9, after traversing the first segment of the resetting motion of the latch 2, as much as possible does not cause any further, then unwanted, inhibition of the resetting motion. This can be accomplished, for example, in that the resistance element 9 is configured and arranged such that, after traversing the first segment of the resetting motion of the latch 2, at the same time, the dead center of the resistance element 9 is crossed so that the resetting motion is no longer inhibited by the resistance element 9, but is now promoted by it. For this reason, the resistance element 9 is pivotably coupled to a stationary housing or the like of the motor vehicle lock 1, on the one hand, and to the additional kinematics 6, 7 on the other hand. This is shown in FIG. 1. The resistance element 9 is made, in this case, as a helical spring.

FIG. 2 likewise shows a resistance element 9 which is made as a spring element. However, here, the resistance element 9 is a leg spring. Crossing dead center of the resistance element 9 is not provided here.

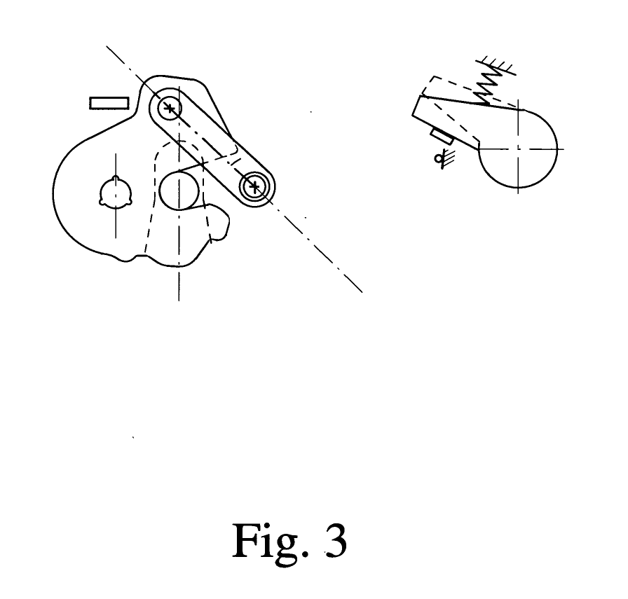

In another preferred configuration, as is shown in FIG. 3. the resistance element 9 can also be made as a damping element. Here, for example, known friction-based or hydraulic damping elements can be used. A resistance element 9 made as a damping element can have, for example, a piston which runs in a cylinder and which achieves the desired damping by friction between the piston and the cylinder wall. The cylinder, however, can also be filled with a liquid which flows from one cylinder space into the other when the damping element (piston) is moved. However, it can also be provided that the resistance element 9 is frictionally connected to one component of the additional kinematics 6, 7 so that, in turn, a corresponding damping effect is achieved.

In an especially preferred configuration, the additional kinematics 6, 7 produce a step-down ratio when the latch 2 is in the fully latched position, so that the force acting from the latch 2 on the additional kinematics 6, 7 is converted into a smaller force acting from the additional kinematics 6, 7 on the resistance element 9. Then, it is such that, for the desired inhibition of the first segment of the resetting motion, a comparatively weak force must be applied by the resistance element 9. The resistance element 9 can be made accordingly weak and thus economical.

It is pointed out that the inhibition of the resetting motion is desirable solely in the first segment of motion in order not to hinder the further opening process. Against this background, it is especially advantageous if the step-down ratio of the additional kinematics 6, 7 decreases when viewed over the resetting motion of the latch 2, so that the above described inhibiting action of the resistance element 9 decreases accordingly.

In a consistent development of the aforementioned idea, when the latch 2 is in the open position, the additional kinematics 6, 7 are ultimately a step-up gearing so that the force acting from the latch 2 on the additional kinematics 6, 7 is converted into a higher force acting from the additional kinematics 6, 7 on the resistance element 9. Then, it is preferably such that the force acting from the latch 2 on the additional kinematics 6, 7 in the opening direction prevails greatly over the inhibiting action of the resistance element 9.

Altogether, the optimum coordination of the step-down or step-up ratio of the additional kinematics 6, 7 to the resistance element 9 and to the pretensioning of the latch 2 which can ordinarily be expected in the opening direction can be determined. In particular, the seal counterpressure which can be expected should be included in this consideration. Furthermore, in the embodiment shown in FIG. 1, it should be taken into account that, in spite of the action of the force of the resistance element 9 on the additional kinematics 6, 7, which may be present when the ratchet 3 is in the holding position, a sufficient blocking force remains between the ratchet 3 and the additional kinematics 6, 7 so that the motor vehicle lock 1 is basically in a defined state.

In the preferred embodiments which are shown in FIGS. 1 & 2, the additional kinematics 6, 7 together with the latch 2 form a four-bar mechanism. For this reason, the additional kinematics 6, 7 have a locking lever 6 which can be pivoted around the pivot axis and an intermediate lever 7 which is pivotably coupled to the latch 2, on the one hand, and to the locking lever 6, on the other. For coupling the intermediate lever 7 to the latch 2 and to the locking lever 6, the corresponding pivot axes 12, 13 are provided. The pivot axis 4 of the latch 2, the pivot axis 12 between the latch 2 and the intermediate lever 7, the pivot axis 13 between the intermediate lever 7 and the locking lever 6 and the pivot axis 11 of the locking lever 6 therefore, together, form the four-bar mechanism.

There is a series of possibilities for how the resistance element 9 can be coupled to the additional kinematics 6, 7. In an especially preferred embodiment, the resistance element 9, for the above described arrangement, is coupled to the locking lever 6. In this way, the gear characteristic of the four-bar mechanism kinematics can be optimally used.

In one preferred configuration, when the latch 2 is in the fully latched position, an obtuse angle is included between the intermediate lever 7 and the locking lever 6 so that the resistance element 9 must apply a very weak force in order to effectively inhibit the resetting motion of the latch 2. The intermediate lever 7 with the locking lever 6 forms a toggle lever mechanism.

Therefore, in the initial state shown in FIGS. 1 & 2, if the ratchet 3 is transferred out of the illustrated holding position into the release position, the seal counterpressure via the striker 2a and spring pretensioning of the latch 2 which may be present causes movement of the latch 2 in the direction of the open position. The resistance element 9 which acts on the locking lever 6 works against this motion of the latch 2. In this state, the additional kinematics 6, 7 deliver a high step-down ratio so that, with the action of a small force of the resistance element 9 on the additional kinematics 6, 7, the action of a large force from the additional kinematics 6, 7 on the latch 2 is induced. In this way, the resetting motion of the latch 2 is inhibited, but not blocked. With further movement of the latch 2 in the direction of the open position, the toggle lever which is formed by the locking lever 6 and the intermediate lever 7 continues to buckle so that the step-down ratio of the additional kinematics 6, 7 decreases.

With a corresponding design, the further resetting motion of the latch 2 by the resistance element 9 is not significantly hindered, preferably not hindered at all. For the embodiment shown in FIG. 1, as explained, it is additionally such that, after traversing the first segment of the resetting motion, dead center of the resistance element 9 is crossed.

In the design of the arrangement, it must finally be taken into account that, in the illustrated exemplary embodiments, with the continuing resetting motion of the latch 2, the step-down ratio of the additional kinematics 6, 7 does decrease, but the resistance elements 9, made as a spring element are further deflected; this leads to an increasing spring force. In the design of the arrangement, it is important that, after traversing the first segment of the resetting motion, the resistance element 9, in spite of increasing spring force, no longer leads to hindrance of the further resetting motion. This can be accomplished, for example, by the above described top dead center arrangement of the resistance element 9 (FIG. 1) or by the corresponding design of the additional kinematics 6, 7 with a variable step-down ratio (FIGS. 1, 2).

Finally, it is pointed out that the configuration of the additional kinematics 6, 7 is not limited to the illustrated form of lever arrangement. For the configuration of the additional kinematics 6, 7, basically, all suitable types of gearing known from the prior art can be used.

What is claimed is:

1. Motor vehicle lock, comprising:
a latch, the latch being able to pivot around a pivot axis, and being movable into at least an open position and a fully latched position and
a ratchet, the ratchet being movable into at least one holding position, in which the latch is held by the ratchet in the fully latched position, and into a release position,
wherein additional kinematics are assigned to the latch, the additional kinematics being coupled in a pivoting and undetachable manner to the latch, wherein a resetting motion of the latch out of the fully latched position in a direction toward the open position is adapted to cause movement of the additional kinematics, and wherein the additional kinematics are coupled during at least a portion of a movement path thereof to a resistance element which is adapted to produce a force acting on the additional kinematics in a manner causing inhibition of at least a first segment of the resetting motion.

2. Motor vehicle lock as claimed in claim 1, wherein the ratchet is coupled to the additional kinematics such that the ratchet is in blocking engagement with the additional kinematics in the holding position and thus keeps the latch in the fully latched position.

3. Motor vehicle lock as claimed in claim 1, wherein the ratchet which is in the holding position is in directly blocking engagement with the latch.

4. Motor vehicle lock as claimed in claim 1, wherein the resistance element is a spring element.

5. Motor vehicle lock as claimed in claim 1, wherein the resistance element is a damping element.

6. Motor vehicle lock as claimed in claim 1, wherein the additional kinematics are adapted to produce a step-down ratio that is active at least when the latch is in the fully latched position, so that the force acting from the latch on the additional kinematics is converted into a smaller force acting from the additional kinematics on the resistance element.

7. Motor vehicle lock as claimed in claim 2, wherein the additional kinematics are adapted to produce a step-down ratio at least when the latch is in the fully latched position, so that the force acting from the latch on the additional kinematics is converted into a smaller force acting from the additional kinematics on the resistance element.

8. Motor vehicle lock as claimed in claim 3, wherein the additional kinematics are adapted to produce a step-down ratio at least when the latch is in the fully latched position, so that the force acting from the latch on the additional kinematics is converted into a smaller force acting from the additional kinematics on the resistance element.

9. Motor vehicle lock as claimed in claim 6, wherein the step down ratio decreases when viewed over the resetting motion of the latch.

10. Motor vehicle lock as claimed in claim 1, wherein the additional kinematics are adapted to produce a step-up ratio at least when the latch is in the open position, so that the force acting from the latch on the additional kinematics is converted into a larger force acting from the additional kinematics on the resistance element.

11. Motor vehicle lock as claimed in claim 6, wherein the additional kinematics are adapted to produce a step-up ratio at least when the latch is in the open position, so that the force acting from the latch on the additional kinematics is converted into a larger force acting from the additional kinematics on the resistance element.

12. Motor vehicle lock as claimed in claim 1, wherein the additional kinematics together with the latch form a four-bar mechanism having a locking lever which can be pivoted around a pivot axis, and an intermediate lever which is pivotably coupled to the latch and to the locking lever.

13. Motor vehicle lock as claimed in claim 12, wherein the resistance element is coupled to the locking lever.

14. Motor vehicle lock as claimed in claim 12, wherein the intermediate lever forms an obtuse angle with the locking lever when the latch is in the fully latched position.

15. Motor vehicle lock as claimed in claim 1, wherein the coupling of the additional kinematics to the resistance element which is adapted to produce a force acting on the additional kinematics in a manner causing inhibition of only the first segment of the resetting motion.

16. Motor vehicle lock as claimed in claim 15, wherein the resistance element is an elastic resistance element.

17. Motor vehicle lock as claimed in claim 1, wherein the resistance element is an elastic resistance element.
